(19) United States
(12) Patent Application Publication
(10) Pub. No.: US 2015/0006526 A1
(43) Pub. Date: Jan. 1, 2015

(54) Determining Locations of Interest to a User

(71) Applicant: Google Inc., Mountain View, CA (US)

(72) Inventors: Krzysztof Duleba, Pfaffikon SZ (CH); Mark Mao, San Mateo, CA (US); Finnegan Southey, San Francisco, CA (US); Chengling Chan, Mountain View, CA (US); Lukasz Andrzej Heldt, Stallikon (CH); Jason Luther Smart, Alamo, CA (US)

(21) Appl. No.: 13/930,608

(22) Filed: Jun. 28, 2013

(51) Int. Cl. G06F 17/30

(52) U.S. Cl. CPC G06F 17/30241
USPC 707/728

(57) ABSTRACT

Provided are systems, methods, and computer-readable media for determining locations of interest to a user. User activity over a period of time is obtained and used to determine geographic entities (e.g., locations) of interest. The user activity is aggregated by geographic entity and a relevancy score is calculated for each geographic entity. The geographic entity having the highest score is stored as a location of interest in a location profile for the user. Multiple geographic entities having the highest specified number of relevancy scores may also be stored.

### BACKGROUND OF THE INVENTION

1. Field of the Invention

This invention relates generally to determining the location of a user and, more particularly, to inferring a location using computer-implemented searches and other data.

2. Description of the Related Art

Location-based applications and services may be accessed by users to obtain information specific to a user's location. Such location-based applications and services may determine the location of a computer (referred to as “geolocation”), such as a smartphone, laptop computer, and the like, and deliver information such as content, advertisements to a user based on the location. The location determinations may include geolocation to obtain the geographic location of the computer. Some businesses employ geolocation techniques to learn more about customers such that the business can provide goods, services, content, and advertisements that may be of particular interest to the customers. For example, a website may employ geolocation techniques to identify the location of a person requesting to view a webpage, and deliver webpage content that may be of particular interest to persons in the location, such as local news, local maps, local advertisements and so forth. However, existing geolocation techniques may not account for other locations of interest to a user. For example, while associating an IP address of a user's computer may identify the current location of the user, the user may be interested in other locations, such as vacation locations, business locations, or other locations accessible from the user's current location.

### SUMMARY OF THE INVENTION

Various embodiments of systems, methods, and computer-readable media determining locations of interest to a user are provided. In some embodiments, a computer-implemented method for determining a location of interest for a user is provided. The method includes obtaining, via one or more processors, user activity occurring over a time period, the user activity associated with one or more geographic entities. The user activity includes previously executed queries submitted by the user and previously selected query results selected by the user. Additionally, the method includes aggregating, via one or more processors the user activity for each of the one or more geographic entities and determining, via one or more processors a relevancy score for each of the one or more geographic entities based on the aggregated user activity. The method also includes determining, via one or more processors, a location of interest for the user based on the relevancy score.

Additionally, in some embodiments a non-transitory tangible computer-readable storage medium having executable computer code stored thereon for determining a location of interest for a user is provided. The code includes a set of instructions that causes one or more processors to perform the following: obtaining, via one or more processors, user activity occurring over a time period, the user activity associated with one or more geographic entities. The user activity includes previously executed queries submitted by the user and previously selected query results selected by the user. Additionally, the code further includes a set of instructions that causes one or more processors to perform the following: aggregating, via one or more processors the user activity for each of the one or more geographic entities and determining, via one or more processors a relevancy score for each of the one or more geographic entities based on the aggregated user activity. The code further includes a set of instructions that causes one or more processors to perform the following: determining, via one or more processors, a location of interest for the user based on the relevancy score.

In some embodiments, a system is provided having one or more processors and a tangible non-transitory memory accessible by the one or more processors and having executable computer code stored thereon. The code includes a set of instructions that causes one or more processors to perform the following: obtaining, via one or more processors, user activity occurring over a time period, the user activity associated with one or more geographic entities. The user activity includes previously executed queries submitted by the user and previously selected query results selected by the user. Additionally, the code further includes a set of instructions that causes one or more processors to perform the following: aggregating, via one or more processors the user activity for each of the one or more geographic entities and determining, via one or more processors a relevancy score for each of the one or more geographic entities based on the aggregated user activity. The code further includes a set of instructions that causes one or more processors to perform the following: determining, via one or more processors, a location of interest for the user based on the relevancy score.

### BRIEF DESCRIPTION OF THE DRAWINGS

FIG. 1 is a block diagram of a process for determining inferred locations of interest to a user in accordance with an embodiment of the present invention;

FIG. 2 is a block diagram of a process for use of an location profile for a user in accordance with an embodiment of the present invention;

FIG. 3 is a block diagram of a system for determining inferred locations of interest to a user in accordance with an embodiment of the present invention; and

FIG. 4 is a block diagram of a computer in accordance with an embodiment of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems, methods, and computer-readable media for determining locations of interest to a user. User activity over a period of time is obtained and used to determine geographic entities (e.g., locations) of interest. The user activity includes maps queries and selections of maps query results, web queries, and selections of web query results. The user activity is aggregated by geographic entity and a relevancy score is calculated for each geographic entity. In some embodiments, the relevancy score is a frequency-based aggregation that is based on the frequency with which the user interacted with each geographic entity within a period of time. The geographic entity having the highest relevancy score is stored as a location of interest in a location profile for the user. In some embodiments, multiple locations of interest (e.g., a specified number of geographic entities with the highest relevancy scores) are stored in a location profile. Additionally, in some embodiments, the user activity is filtered by interest categories, such as restaurants, bars, hotels, travel, and so on. In such embodiments, the filtered user activity is aggregated by geographic entity and a relevancy score is calculated for each geographic entity. In some embodiments, as mentioned above, the relevancy score is a frequency-based aggregation that is based on the frequency with which the user interacted with each geographic entity within a period of time. The geographic entity having the highest relevancy is stored as a location of interest (e.g., a specified number of geographic entities with the highest relevancy scores) in a category-specific location profile for the user, and multiple locations of interest may be stored based on the highest relevancy scores.

Moreover, the location profile for a user is refreshed based on refresh criteria, such as elapsed time since the last profile generation, occurrence of an event, such as a deletion of some or all of the user's activity history, a specific number of user activities (e.g., additional query submissions), occurrence of user activity that do not fit the generated location profiles, and other events. A generated location profile is used in location-based processing of submitted user queries. For example, after a user submits a query, the location profile for the user is obtained and usage criteria are evaluated. If the usage criteria are met, the location from the location profile is used for processing the query. If the usage criteria are not met, the user's current location (as obtained from IP address geolocation or other known techniques) is used as the location for processing the query.

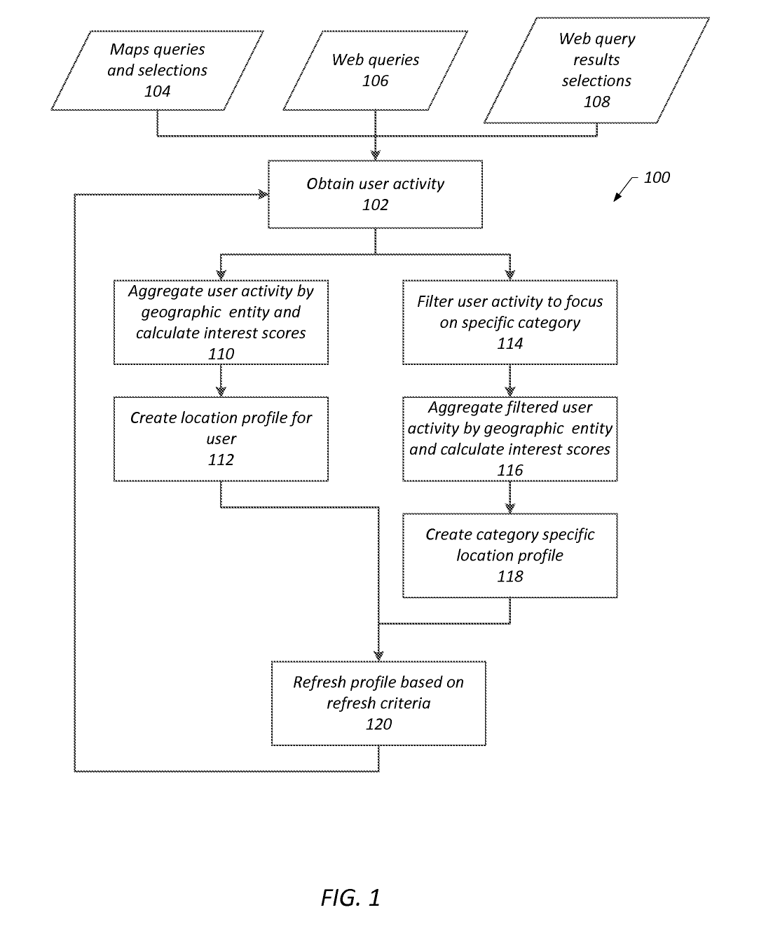

FIG. 1 depicts a process 100 for determining locations of interest to a user (also referred to as “inferred locations”) in accordance with an embodiment of the present invention. Some or all steps of the process 100 may be implemented as executable computer code stored on a non-transitory tangible computer-readable storage medium and executed by one or more processors of a special-purpose machine, e.g., a computer programmed to execute the code. As shown in FIG. 1, user activity is obtained and used to determine the locations of interest (block 102). The user activity includes, for example, maps queries and selections (block 104). The maps queries and selections include queries entered to search a computer-implemented geographic map, and the selections include selections of results displayed on the computer-implemented geographic maps, such as entities displayed in response to the queries. Additionally, web queries submitted by the user are obtained (block 106). The queries may include queries submitted to a search engine via, for example, a webpage. Additionally, the obtained user activity also includes query results selections (block 108). For example, results responsive to a submitted query may be presented to a user via a webpage. A user may select a query result (e.g., by selecting a hyperlink) to obtain further information about a result or access a document (e.g., a webpage). Additionally, it should be appreciated that the obtained user activity may include various other types of activities, such as queries and results selections submitted through applications (e.g., native applications on portable computer such as smartphone).

In some embodiments, after obtaining user activity, the user activity is aggregated by geographic entity (block 110). A geographic entity may refer to a human settlement such as a city, town, village, and the like, a state, province, or other government territory of a country, a country, a neighborhood, and so on. In some embodiments, the aggregation by geographic entity is a frequency-based aggregation that is based on the frequency with which the user interacted with each geographic entity within a period of time. In some embodiments, the interaction frequencies may be within the previous 1 day or greater, previous 2 days or greater, previous 7 days or greater, previous 30 days or greater, previous 60 days or greater, previous 180 days or greater, any other suitable time period, or combination thereof. In such embodiments, the frequency-based aggregation includes a weighted aggregation having higher weights on the most recent frequency. In one such embodiment, the previous 2 day interactions have a weight of 0.5, the previous 7 day interactions have a weight of 0.25, the previous 30 day interactions have a weight of 0.125, and any less recent time periods such as previous 60 day and previous 180 day interactions have a weight of 0.0625. For example, if user's interaction frequency for interactions with New York City is 50% within the previous 2 days, 10% within the previous 7 days, 10% within the previous 30 days, 5% within the previous 60 days, and 2% within the previous 180 days, the relevancy aggregation for New York City for the user is (50%*0.5)+(10% *0.25)+(5%*0.125)+(5%*0.0625)+(2%*0.0625)=29.1875%. Each geographic entity of aggregation may have a calculated relevancy score. In some embodiments, geographic entities having a relevancy score below a threshold may be omitted from the locations of interest.

After determining the relevancy scores, a location profile is generated for the user (block 112). In some embodiments, the geographic entity having the highest relevancy score is stored as the location of interest (“inferred location”) in the location profile. In other embodiments, the location profile may store multiple locations, such that a specific number of geographic entities having the highest relevancy scores are stored as locations of interest. As described further below, the location profile is used during location-based processing of subsequent user activity (such as submitted queries).

In some embodiments, location profiles are generated for specific categories of interest. Such interest categories may include, for example, restaurants, hotels, manufacturers or types of products, providers and types of services, and so on. In such embodiments, after obtaining the user activity in the manner described above, the user activity is filtered to focus on a specific category (block 114). For example, the maps queries and selections, web queries, and web query results and selections, may be filtered for the activity associated with a “restaurant” category. After filtering, the filtered user activity is aggregated by geographic entity to determine relevancy scores for each entity (block 116). In some embodiments, the aggregation is a frequency-based aggregation that is based on the frequency with which the user interacted with each geographic entity within a period of time. In some embodiments, the frequency-based aggregation may use the weighting described above. After determining relevancy scores for the geographic entities, a category specific location profile is generated (block 118). The category specific location profile includes the relevancy scores for each geographic entity used in the aggregation described above. As described below, the category specific location profile is used during location-based processing of subsequent user activity relevant to the category. For example, if a user submits a query for “pizza,” a location profile specific to “restaurants” may be used to provide a location of interest.

As shown in FIG. 1, the generated location profiles are refreshed based on refresh criteria (block 120). In some embodiments, the refresh criteria include elapsed time since the last profile generation, such as 24 hours. In some embodiments, the refresh criteria includes occurrence of an event, such as a deletion of some or all of the user's activity history, a specific number of user activities (e.g., additional query submissions), occurrence of user activity that do not fit the generated location profiles, and other events. After the refresh criteria are met, the user activity is re-obtained and re-aggregated in the manner described above, and a refreshed user profile is generated.

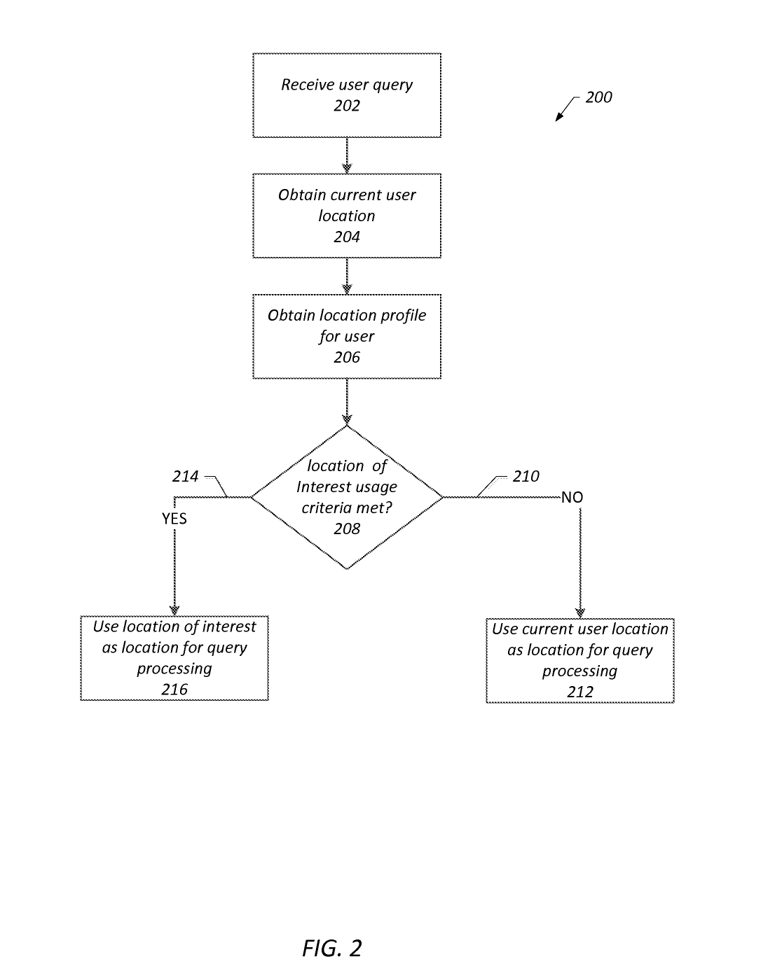

FIG. 2 depicts a process 200 illustrating use of a location profile for a user in accordance with an embodiment of the present invention. Some or all steps of the process 200 may be implemented as executable computer code stored on a non-transitory tangible computer-readable storage medium and executed by one or more processors of a special-purpose machine, e.g., a computer programmed to execute the code. Although the process 200 is described with reference to processing a query, it should be appreciated that other location-based processing may use the location profiles described herein to determine a location of interest of a user.

Initially, a user query is received (block 202). For example, a user may submit a query via a webpage, an application on a portable computer, or other submission mechanism. Next, the current user location is obtained (block 204) using known locating techniques; such determining the location from a token (e.g., IP address geolocation) or receiving a location determined via communication with a satellite-based positing system (e.g., the Global Positioning System (GPS)). Additionally, the location profile for a user is obtained (block 206). If no location profile is available, the current location is used as the location for subsequent location-specific processing.

Next, usage criteria for locations of interest (also referred to as “inferred locations) are evaluated to determine whether the inferred location or the user's current location should be used (decision block 208). In some embodiments, the usage criteria include the distance between a location of interest and the current location. For example, in some embodiments, the usage criteria are met if the location of interest is within 50 kilometers of the user's current location. In other embodiments, the usage criteria are met if the location of interest is within 10 kilometers or greater, 20 kilometers or greater, 30 kilometers or greater, 40 kilometers or greater, and so on. In some embodiments, the usage criteria are category specific based on the category of the query or other submission used in location-specific processing. For example, if the submitted query is categorized into a “travel” category, the usage criteria may not include any distance criteria. In some embodiments, the usage criteria may include the age of the location profiles for the user or other suitable criteria.

If the usage criteria are not met (line 210), the current location is used as the location for processing the query (block 212). If the usage criteria are met (line 214), then the location of interest from the location profile is used as the location for processing the query (block 216). For example, if the user's current location is Palo Alto, Calif., but the user has recently been searching San Francisco for restaurants, bars, or other locations to visit on the weekend, the location of interest in the user's location profile may be San Francisco, Calif. Consequently, the location of interest of San Francisco, Calif., may be used in processing the query.

Moreover, is should be appreciated that the process 200 described above and illustrated in FIG. 2 may also be used for category-specific queries and location profiles. After the user query is received, a category-specific location profile may be obtained and used depending on the evaluation of the usage criteria described above. In such embodiments, as mentioned above, the usage criteria may be category specific. For example, usage criteria for a category of “restaurants” may have a smaller distance threshold between the location of interest and the user's current location than usage criteria for a category of “travel.”

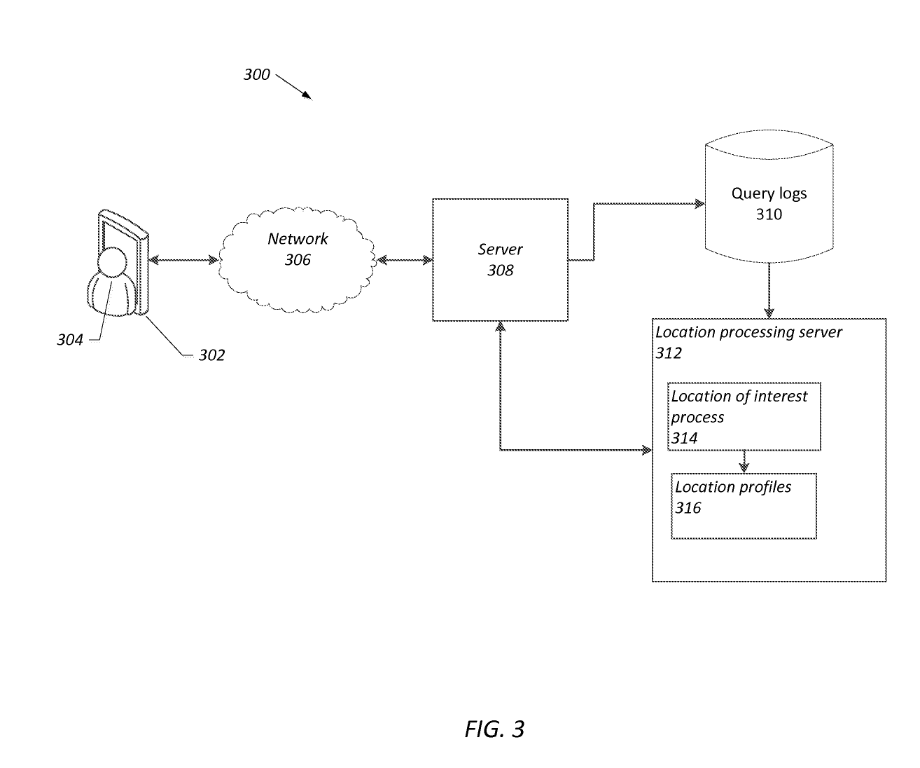

FIG. 3 depicts a system 300 for determining locations of interest for a user in accordance with an embodiment of the present invention. The system 300 may include a user device 302 associated with a user 304, a network 306, and a server 308. The system 300 also includes query logs 310, as well as a location processing server 312. The user device 302 may include desktop computers, laptop computers, tablet computers, smartphones, personal digital assistants, etc., and may include a receiver for a satellite-based positioning system, such as a Global Positioning System (GPS) receiver. The user 304 may use the user device 302 to retrieve information, view interactive maps, and perform computer-implemented searches, such as by entering search queries that are received and processed by the server 308.

The server 308 may receive and process queries received from the user device 302. For example, in some embodiments the server 308 may include a maps server for processing map queries and providing computer-implemented maps and results to map queries. In some embodiments, the server 308 may include a search engine for processing queries, such as web queries, and providing results responsive to such queries. In some embodiments, the server 308 may merely receive queries from the user device 302 and transmit the queries to yet other servers for further processing. In such embodiments, the server 308 may receive responses to the queries from other servers and may provide the results to the user device 302.

The server 308 may include a single server in a discrete hardware component or as a virtual server) or multiple servers that may include servers, application servers, or other types of servers. The servers may each be, for example computers arranged in any physical and virtual configuration, such as computers in one or more data processing centers, a distributed computing environment, or other configuration. In some embodiments, the server 308 may include or may be a part of a geographic information system (GIS) or other systems.

The user device 302 and server 308 are in communication with the network 306, such as through a wired or wireless network interface. In some embodiments, the network 306may include multiple networks, and may include any suitable network and networking technology, such as the Internet, an intranet, a local area network (LAN), a wide area network (WAN), or any other suitable network. Additionally, the network 306 may include a wired network, a wireless network, or both. Moreover, it should be appreciated that the user device 302 and server 308 may communicate over different networks separately and simultaneously. For example, the user device 302 may communicate over both a wireless Ethernet network and a cellular network.

As mentioned above, the server 308 receives queries from the user device 302 via the network 306. The server 308 may include or have access to query logs 310. The queries received from the user device 302 are stored in the query logs 310. The query logs 310 may include multiple logs that store different types of queries. For example, in one embodiment the query logs 310 may include map query logs that store map queries and web query logs that store web queries. Additionally, in some embodiments the query logs 310 may include selections of query results by the user 304. For example, after providing results responsive to a submitted query, the user 304 may select a result to obtain further information or view a document. The selection may also be stored in the query logs 310 and, as described above, the query logs 310 may store map query result selections and web query result selections. As will be appreciated, the query logs 310 may store other data related to a query and selections, such as a timestamp, a user session identifier, and so on.

As mentioned above, the system 300 includes a location processing server 312. The location processing server 312 may include a single server in a discrete hardware component or as a virtual server) or multiple servers that may include servers, application servers, or other types of servers. The servers may each be, for example computers arranged in any physical and virtual configuration, such as computers in one or more data processing centers, a distributed computing environment, or other configuration.

The location processing server 312 includes a location of interest process 314 that determines locations of interest and generates location profiles 316 for a user. The location of interest process 314 obtains user activity, such as queries and results selections, from the query logs 310, aggregates the user activity by geographic entity, and determines relevancy scores for geographic entities from the aggregation, such as described above and illustrated in FIG. 1. As also described above, a location profile 316 for the user 302 is generated. In some embodiments, the location profile 316 includes a single location of interest, e.g., the most relevant geographic entity based on the relevancy score. In other embodiments, the location profile 316 includes multiple inferred locations, e.g., a specific number of the most relevant geographic entities based on the relevancy scores. Moreover, as also described above, in some embodiments the location of interest process 314 may generate a category-specific location profile, such as profile for “restaurants” or other categories. In such embodiments, as described above, the location of interest process 314 filters the user activity obtained from the query logs 310 to focus on a specific category.

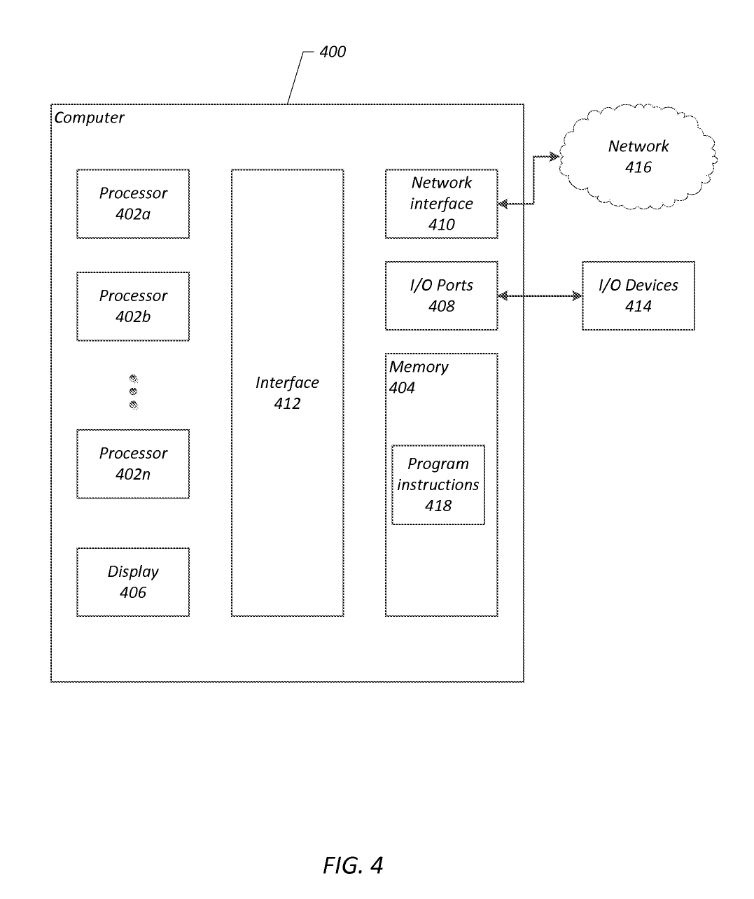

FIG. 4 depicts a computer 400 in accordance with an embodiment of the present invention. Various portions or sections of systems and methods described herein include or are executed on one or more computers similar to computer 400 and programmed as special-purpose machines executing some or all steps of processes described above as executable computer code. Further, processes, modules, and other components described herein may be executed by one or more processing systems similar to that of computer 400.

The computer 400 may include various components that contribute to the function of the device and enable the computer 400 to function in accordance with the techniques discussed herein. As will be appreciated, some components of computer 400 may be provided as internal or integral components of the computer 400 and some components may be provided as external or connectable components. Moreover, FIG. 4 depicts one example of a particular implementation and is intended to illustrate the types of components and functions that may be present in various embodiments of the computer 400.

Computer 400 may include a combination of devices or software that may perform or otherwise provide for the performance of the techniques described herein. For example, computer 400 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. The computer 400 may be a unified device providing any one of or a combination of the functionality of a media player, a cellular phone, a personal data organizer, a game console, and so forth. Computer 400 may be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available. As shown in the embodiment illustrated in FIG. 4, the computer 400 may include one or more processors (e.g., processors 402a-402n), a memory 404, a display 406, I/O ports 408 a network interface 410, and an interface 412. Additionally, the computer 400 may include or be coupled to I/O devices 414.

In addition, the computer 400 may allow a user to connect to and communicate through a network 416 (e.g., the Internet, a local area network, a wide area network, etc.) and, in some embodiments, to acquire data from a satellite-based positioning system (e.g., GPS). For example, the computer 400 may allow a user to communicate using e-mail, text messaging, instant messaging, or using other forms of electronic communication, and may allow a user to obtain the location of the device from a satellite-based positioning system.

In some embodiments, the display 406 may include a liquid crystal display (LCD) an organic light emitting diode (OLED) display, or other display types. The display 406 may display a user interface (e.g., a graphical user interface) executed by the processor 402 of the computer 400. The display 406 may also display various indicators to provide feedback to a user, such as power status, call status, memory status, network status etc. These indicators may be incorporated in the user interface displayed on the display 406. In some embodiments, the display 406 may include or be provided in conjunction with touch sensitive elements through which a user may interact with the user interface. In such embodiments, a touch-sensitive display may be referred to as a “touch screen” and may also be known as or called a touch-sensitive display system.

The processor 402 may provide the processing capability to execute the operating system, programs, user interface, and other functions of the computer 400. The processor 402 may include one or more processors and may include “general-purpose” microprocessors, special purpose microprocessors, such as application-specific integrated circuits (ASICs), or any combination thereof. In some embodiments, the processor 402 may include one or more reduced instruction set (RISC) processors, such as those implementing the Advanced RISC Machine (ARM) instruction set. Additionally, the processor 402 may include single-core processors and multicore processors and may include graphics processors, video processors, and related chip sets. Accordingly, the computer 400 may be a uni-processor system having one processor (e.g., processor 402a), or a multi-processor system having two or more suitable processors (e.g., 402a-402n). Multiple processors may be employed to provide for parallel or sequential execution of the techniques described herein. Processes, such as logic flows, described herein may be performed by the processor 402 executing one or more computer programs to perform functions by operating on input data and generating corresponding output. The processor 402 may receive instructions and data from a memory (e.g., system memory 404).

The memory 404 (which may include one or more tangible non-transitory computer readable storage mediums) may include volatile memory and non-volatile memory accessible by the processor 402 and other components of the computer 400. The memory 404 may store a variety of information and may be used for a variety of purposes. For example, the memory 404 may store executable computer code, such as the firmware for the computer 400, an operating system for the computer 400, and any other programs or other executable code for providing functions of the computer 400. Such executable computer code may include program instructions 418 executable by a processor (e.g., one or more of processors 402a-402n) to implement one or more embodiments of the present invention, such as the process 100 or the process 200 described above. Program instructions 418 may include modules of computer program instructions for implementing one or more techniques described herein. Program instructions 418 may include a computer program (which in certain forms is known as a program, software, software application, script, or code). A computer program may be written in a programming language, including compiled or interpreted languages, or declarative or procedural languages. A computer program may include a unit suitable for use in a computing environment, including a stand-alone program, a module, a component, a subroutine, and the like. A computer program may or may not correspond to a file in a file system. A computer program may be stored in a section of a file that holds other computer programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more processors located locally at one site or distributed across multiple remote sites and interconnected by a communication network. Additionally, the memory 404 may be used for buffering or caching during operation of the computer 400.

As mentioned above, the memory 404 may include volatile memory, such as random access memory (RAM). The memory 404 may also include non-volatile memory, such as ROM, flash memory, a hard drive, other suitable optical, magnetic, or solid-state storage mediums or any combination thereof. The memory 404 may store data files such as media (e.g., music and video files), software (e.g., for implementing functions on computer 400), user preference information, payment transaction information, wireless connection information, contact information (e.g., an address book), and any other suitable data.

The interface 412 may include multiple interfaces and may enable communication between various components of the computer 400, the processor 402, and the memory 404. In some embodiments, the interface 412, the processor 402, memory 404, and one or more other components of the computer 400 may be implemented on a single chip, such as a system-on-a-chip (SOC). In other embodiments, these components, their functionalities, or both may be implemented on separate chips. The interface 412 may coordinate I/O traffic between processors 402a-402n, the memory 404, the network interface 410, 414, or any other devices or a combination thereof. The interface 412 may perform protocol, timing or other data transformations to convert data signals from one component (e.g., the memory 404) into a format suitable for use by another component (e.g., processors 402a-402n). The interface 412 may implement various types of interfaces, such as Peripheral Component Interconnect (PCI) interfaces, the Universal Serial Bus (USB) interfaces, Thunderbolt interfaces, Firewire (IEEE-1394) interfaces, and so on.

The computer 400 may also include an input and output port 408 to enable connection of additional devices, such as I/O devices 414. Embodiments of the present invention may include any number of input and output ports 408, including headphone and headset jacks, universal serial bus (USB) ports, Firewire (IEEE-1394) ports, Thunderbolt ports, and AC and DC power connectors. Further, the computer 400 may use the input and output ports to connect to and send or receive data with any other device, such as other portable computers, personal computers, printers, etc.

The computer 400 depicted in FIG. 4 also includes a network interface 410. The network interface 410 may include a wired network interface card (NIC), a wireless (e.g., radio frequency) network interface card, or combination thereof. The network interface 410 may include known circuitry for receiving and sending signals to and from communications networks, such as an antenna system, an RF transceiver, an amplifier, a tuner, an oscillator, a digital signal processor, a modem, a subscriber identity module (SIM) card, memory, and so forth. The network interface 410 may communicate with networks (e.g., network 416), such as the Internet, an intranet, a cellular telephone network, a wide area network (WAN), a local area network (LAN), a metropolitan area network (MAN), or other devices by wired or wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11 standards), voice over Internet Protocol (VoIP), Wi-MAX, an email protocol (e.g., Internet message access protocol (IMAP) or post office protocol (POP)), message-oriented protocols (e.g., extensible messaging and presence protocol (XMPP), Multimedia Messaging Service (MMS), Short Message Service (SMS), or any other suitable communications standards, protocols, and technologies.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for determining a location of interest for a user, comprising:
obtaining, via one or more processors, user activity occurring over a time period, the user activity associated with one or more geographic entities and including:
previously executed queries submitted by the user; and
previously selected query results selected by the user;
aggregating, via one or more processors the user activity for each of the one or more geographic entities;
determining, via one or more processors a relevancy score for each of the one or more geographic entities based on the aggregated user activity; and
determining, via one or more processors, a location of interest for the user based on the relevancy score.

2. The computer-implemented method of claim 1, wherein determining, via one or more processors a relevancy score for each of the one or more geographic entities comprises:
determining from the user activity a frequency of interaction with each of the one or more geographic entities for one or more interaction time periods;
calculating the relevancy score for each of the one or more geographic actions from the frequency of interaction at each interaction time period.

3. The computer-implemented method of claim 1, wherein the previously executed queries comprise queries for searching a computer-implemented geographic map.

4. The computer-implemented method of claim 1, wherein the previously selected query results comprise query results selected from the computer-implemented geographic map.

5. The computer-implemented method of claim 1, wherein the previously selected query results comprise webpages provided in response to one of the previously executed queries, wherein each webpage is associated with the one or more geographic entities.

6. The computer-implemented method of claim 1, comprising filtering the user activity for a category, wherein the relevancy score and location of interest are determined for the category.

7. The computer-implemented method of claim 1, comprising storing the location of interest in a location profile for the user, wherein the location profile is used to provide a location for location-based processing of queries submitted by the user.

8. A non-transitory tangible computer-readable storage medium having executable computer code stored thereon for determining a location of interest for a user, the code comprising a set of instructions that causes one or more processors to perform the following:
obtaining, via one or more processors, user activity occurring over a time period, the user activity associated with one or more geographic entities and including:
previously executed queries submitted by the user; and
previously selected query results selected by the user;
aggregating, via one or more processors the user activity for each of the one or more geographic entities;
determining, via one or more processors a relevancy score for each of the one or more geographic entities based on the aggregated user activity; and
determining, via one or more processors, a location of interest for the user based on the relevancy score.

9. The non-transitory tangible computer-readable storage medium of claim 8, wherein determining, via one or more processors a relevancy score for each of the one or more geographic entities comprises:
determining from the user activity a frequency of interaction with each of the one or more geographic entities for one or more interaction time periods;
calculating the relevancy score for each of the one or more geographic actions from the frequency of interaction at each interaction time period.

10. The non-transitory tangible computer-readable storage medium of claim 8, wherein the previously executed queries comprise queries for searching a computer-implemented geographic map.

11. The non-transitory tangible computer-readable storage medium of claim 8, wherein the previously selected query results comprise query results selected from the computer-implemented geographic map.

12. The non-transitory tangible computer-readable storage medium of claim 8, wherein the previously selected query results comprise webpages provided in response to one of the previously executed queries, wherein each webpage is associated with the one or more geographic entities.

13. The non-transitory tangible computer-readable storage medium of claim 8, the computer code further comprising a set of instructions that causes one or more processors to perform the following: filtering the user activity for a category, wherein the relevancy score and location of interest are determined for the category.

14. The non-transitory tangible computer-readable storage medium of claim 8, the computer code further comprising a set of instructions that causes one or more processors to perform the following: storing the location of interest in a location profile for the user, wherein the location profile is used to provide a location for location-based processing of queries submitted by the user.

15. A system for determining a location of interest for a user, the system comprising:
one or more processors;
a tangible non-transitory memory accessible by the one or more processors and having executable computer code stored thereon, the code comprising a set of instructions that causes one or more processors to perform the following:
obtaining, via one or more processors, user activity occurring over a time period, the user activity associated with one or more geographic entities and including:
previously executed queries submitted by the user; and
previously selected query results selected by the user;
aggregating, via one or more processors the user activity for each of the one or more geographic entities;
determining, via one or more processors a relevancy score for each of the one or more geographic entities based on the aggregated user activity; and
determining, via one or more processors, a location of interest for the user based on the relevancy score.

16. The system of claim 15, wherein determining, via one or more processors a relevancy score for each of the one or more geographic entities comprises:
determining from the user activity a frequency of interaction with each of the one or more geographic entities for one or more interaction time periods;
calculating the relevancy score for each of the one or more geographic actions from the frequency of interaction at each interaction time period.

17. The system of claim 15, wherein the previously executed queries comprise queries for searching a computer-implemented geographic map.

18. The system of claim 15, wherein the previously selected query results comprise query results selected from the computer-implemented geographic map.

19. The system of claim 15, wherein the previously selected query results comprise webpages provided in response to one of the previously executed queries, wherein each webpage is associated with the one or more geographic entities.

20. The system of claim 15, the computer code further comprising a set of instructions that causes one or more processors to perform the following: filtering the user activity for a category, wherein the relevancy score and location of interest are determined for the category.

21. The system of claim 15, the computer code further comprising a set of instructions that causes one or more processors to perform the following: storing the location of interest in a location profile for the user, wherein the location profile is used to provide a location for location-based processing of queries submitted by the user.
